(19) United States
(12) Patent Application Publication
(10) Pub. No.: US 2010/0253883 A1
(43) Pub. Date: Oct. 7, 2010

(54) LIQUID CRYSTAL DISPLAY DEVICE

(75) Inventor: Yoshiteru TOMIZUKA, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/748,684

(22) Filed: Mar. 29, 2010

(30) Foreign Application Priority Data
Apr. 7, 2009 (JP) 2009-092864

(51) Int. Cl. G02F 1/13357

(52) U.S. Cl. 349/65

(57) ABSTRACT

The present invention provides a liquid crystal display device, wherein the backlight has a light guiding plate, a first light source group made up of light sources aligned along a first side of the light guiding plate and a second light source group made up of light sources aligned along a second side that faces the first side, the first light source group has a first region where the distance between adjacent light sources is a first distance and a second region where the distance between adjacent light sources is a second distance that is smaller than the first distance, the second light source group has a third region facing the first region and a fourth region facing the second region, the third distance between adjacent light sources in the third region is smaller than the fourth distance between adjacent light sources in the fourth region, and semiconductor devices are positioned so as to face the first region.

### CROSS-REFERENCE TO RELATED APPLICATION

The present application claims priority over Japanese Application JP2009-092864 filed on Apr. 7, 2009, the contents of which are hereby incorporated into this application by reference.

### BACKGROUND OF THE INVENTION

(1) Field of the Invention

The present invention relates to a liquid crystal display device, and in particular, to a liquid crystal display device having a liquid crystal display panel and a backlight of a so-called edge light type provided on the rear of this liquid crystal display panel.

(2) Description of the Related Art

Liquid crystal display panels have such a structure that the amount of light that transmits through the pixels that form the image display region of the panel can be controlled, and therefore, the backlight of liquid crystal display panels is usually provided in the rear.

There are backlights of an edge light type, for example, which are formed of a light guiding plate that is positioned so as to face a least the image display region of the liquid crystal display panel, and a light source that is positioned along the side wall of at least one side of the light guiding plate. Such backlights function as a surface light source where light from the light source passes through the side wall so as to be guided into the light guiding plate and is repeatedly reflected within the light guiding plate, and after that emitted through the surface facing the liquid crystal display panel.

Though in some cases a cold cathode ray tube, for example, is used for the light source, recently light sources made up of a number of light sources which are close to dot light sources in shape, such as light emitting diodes (LED's) and aligned, are also used. In this case, the light sources are aligned at equal intervals. This is because the brightness has to be uniform on the main surface of the light guiding plate facing the liquid crystal display panel. Such a backlight is disclosed in JP2008-89944A, for example.

### SUMMARY OF THE INVENTION

In addition, a semiconductor device (for example a driver IC chip) is mounted along at least one side outside the image display region. The above described semiconductor device is provided so that a large number of pixels that form the image display region can be independently driven.

In this case, the side of the liquid crystal display panel along which the above described semiconductor device is mounted is located on the same side of the backlight as the side along which a number of light emitting diodes (LED's) are aligned as described above, and as a result, several light emitting diodes are in the proximity of the above described semiconductor device. Therefore, the above described semiconductor device is easily affected by the heat from the light emitting diodes provided in the proximity thereof, and thus, the properties easily deteriorate.

FIG. 3 is a plan diagram showing the positional relationship between a light guiding plate GLB, light emitting diodes LD that are positioned along a side wall of this light guiding plate GLB, and a semiconductor device (indicated by the dotted box SEC in the figure) on the liquid crystal display panel (not shown) in the backlight BL. Here, FIG. 3 corresponds to FIG. 1, which shows an embodiment of the present invention, and the descriptions for FIG. 1 should be referred to for the structure in FIG. 3, except for the part described below.

In FIG. 3, a number of light emitting diodes LD (LD1 in the figure) are provided and aligned along the first side wall WF1 on the side of the light guiding plate GLB where semiconductor devices SEC are provided. These light emitting diodes LD are provided at equal intervals (with a pitch W0 of 14.1 mm for 10.5 inch liquid crystal panels). In this case, there are three semiconductor devices SEC, for example, the width W1 is 19.0 mm, and the distance D between adjacent semiconductor devices SEC is 23.2 mm. Three light emitting diodes DL1 are provided in the proximity of one semiconductor device SEC, and the above described semiconductor devices SEC are easily affected by the heat from the three light emitting diodes DL1.

Here, FIG. 3 shows a structure where a number of light emitting diodes LD (LD2 in the figure) are aligned along the second side wall WF2 that faces the above described first side wall WF1. This is because the brightness of the backlight BL has to be higher. These light emitting diodes LD2 are aligned at equal intervals with the same pitch W0 as the light emitting diodes LD1 provided along the first side wall WF1 and shifted over half a pitch from the light emitting diodes LD1. This is because the brightness of the backlight BL has to be uniform.

In order to avoid the above described disadvantage of the backlight BL having such a structure, it is possible to reduce the number of light emitting diodes LD1 provided in the proximity of the semiconductor devices SEC, as described above, so that the effects of heat on the above described semiconductor devices SEC can be reduced. By doing so, however, it becomes difficult to make the brightness of the backlight BL uniform.

An object of the present invention is to provide a liquid crystal display device where the effects of heat on the semiconductor devices on the liquid crystal display panel can be reduced and the brightness of the backlight can be made uniform.

In the liquid crystal display device according to the present invention, a number of light emitting diodes (first light source group) are aligned along the side wall of the side (first side) of the light guiding plate corresponding to the side of the liquid crystal display panel along which semiconductor devices are mounted, and at the same time, a number of light emitting diodes (second light source group) are aligned along the side wall of the side (second side) that faces the above described first side, so that there is a difference in pitch between the light emitting diodes in the above described first light source group, so that the pitch is longer in places where the above described semiconductor devices are located, while there is a difference in pitch between the light emitting diodes in the above described second light source group, so that the pitch is shorter in places that correspond to places where the pitch between the light emitting diodes in the above described first light source group is longer.

Furthermore, the present invention can provide the following structures, for example.

(1) The liquid crystal display according to the present invention is a liquid crystal display device having a liquid crystal display panel and a backlight provided on the rear of the above described liquid crystal display panel, characterized in that

the above described backlight has a light guiding plate provided so as to face at least an image display region of the above described liquid crystal display panel, a first light source group made up of a number of light sources that are aligned along a side wall of a first side of the above described light guiding plate and a second light source group made up of a number of light sources aligned along a side wall of a second side that faces the above described second side of the above described light guiding plate,

the first light source group has a first region where the distance between adjacent light sources is a first distance and a second region where the distance between adjacent light sources is a second distance that is smaller than the above described first distance,

the above described second light source group has a third region that faces the above described first region and a fourth region that faces the above described second region,

the distance between adjacent light sources in the above described third region is a third distance, the distance between adjacent light sources in the above described fourth region is a fourth distance, and the above described third distance is smaller than the above described fourth distance.

(2) The liquid crystal display according to (2) of the present invention is the liquid crystal display device according to (1), characterized in that at least one semiconductor device is provided along the side of the above described liquid crystal panel on the above described first side, and the above described semiconductor device is positioned so as to face the above described first region.

(3) The liquid crystal display device according to (3) of the present invention is the liquid crystal display device according to (2), characterized in that there are a number of semiconductor devices.

(4) The liquid crystal display device according to (4) of the present invention is the liquid crystal display device according to any of (1) to (3), characterized in that the sum of the number of light sources provided in the above described first region and the number of light sources provided in the above described third region is equal to the sum of the number of light sources provided in the above described second region and the number of light sources provided in the above described fourth region.

(5) The liquid crystal display device according to (5) of the present invention is the liquid crystal display device according to any of (1) to (4), characterized in that the relation between the above described first distance and the above described second distance is such that first distance/second distance ≦1.6.

(6) The liquid crystal display device according to (6) of the present invention is the liquid crystal display device according to (5), characterized in that the relation between the above described third distance and the above described fourth distance is such that fourth distance/third distance ≦1.6.

(7) The liquid crystal display device according to (7) of the present invention is the liquid crystal display device according to any of (1) to (6), characterized in that the above described first distance and the above described fourth distance are equal.

(8) The liquid crystal display device according to (8) of the present invention is the liquid crystal display device according to (7), characterized in that the above described second distance and the above described third distance are equal.

(9) The liquid crystal display device according to (9) of the present invention is the liquid crystal display device according to any of (1) to (8), characterized in that the width of the above described side wall of the above described light guiding plate is greater at a point facing the above described second region than at a point facing the above described first region, and the width of the above described side wall of the above described light guiding plate is greater at a point facing the above described third region than at a point facing the above described fourth region.

(10) The liquid crystal display device according to (10) of the present invention is the liquid crystal display device according to (9), characterized in that the above described light guiding plate has a first recess and a second recess on at least the front or rear surface, the above described first recess is created so as to extend to the above described second side from the point where the above described side wall makes contact with the above described first region, and the above described second recess is created so as to extend to the above described first side from the point where the above described side wall makes contact with the above described fourth region.

(11) The liquid crystal display device according to the present invention is a liquid crystal display device having a liquid crystal display panel and a backlight provided on the rear of the above described liquid crystal display panel, characterized in that the above described backlight has a light guiding plate provided so as to face at least an image display region of the above described liquid crystal display panel, a first light source group made up of a number of light sources that are aligned along a side wall of a first side of the above described light guiding plate and a second light source group made up of a number of light sources aligned along a side wall of a second side that faces the above described second side of the above described light guiding plate, the first light source group has a first region where the distance between adjacent light sources is a first distance and a second region where the distance between adjacent light sources is a second distance that is smaller than the above described first distance, at least one semiconductor device is provided along the side of the above described liquid crystal panel on the first side, and the above described semiconductor device is positioned so as to face the above described first region.

(12) The liquid crystal display device according to (12) of the present invention is the liquid crystal display device according to (11), characterized in that there are a number of semiconductor devices.

(13) The liquid crystal display device according to (13) of the present invention is the liquid crystal display device according to (11) or (12), characterized in that the relation between the above described first distance and the above described second distance is such that first distance/second distance ≦1.6.

(14) The liquid crystal display device according to (14) of the present invention is the liquid crystal display device according to any of (11) to (13), characterized in that the width of the above described side wall of the above described light guiding plate is greater at a point facing the above described second region than at a point facing the above described first region.

(15) The liquid crystal display device according (15) of the present invention is the liquid crystal display device according to (14), characterized in that the above described light guiding plate has a recess on at least the front or rear surface, and the above described recess is created so as to extend to the above described second side from the point where the above described side wall makes contact with the above described first region.

(16) The liquid crystal display device according to (16) of the present invention is the liquid crystal display device according to any of (1) to (15), characterized in that the above described light sources are light emitting diodes (LED's).

Here, the above described structures are merely examples, and the present invention can be modified within such a scope as not to depart from the technological idea. In addition, examples of the structure of the present invention other than those described above will become clearer from the description throughout the present specification and the drawings.

Other effects of the present invention will become more clear from the description throughout the present specification.

### BRIEF DESCRIPTION OF THE DRAWINGS

FIG. 1 is a plan diagram showing the backlight of the liquid crystal display device according to one embodiment of the present invention;

FIG. 2 is a plan diagram showing the liquid crystal display device according to one embodiment of the present invention;

FIG. 3 is a diagram for illustrating a problem with the prior art; and

FIGS. 4A and 4B are plan diagrams showing the backlight of the liquid crystal display device according to another embodiment of the present invention.

### DESCRIPTION OF THE PREFERRED EMBODIMENTS

Embodiments of the present invention are described in reference to the drawings. Here, the same symbols are used for components that are the same or similar in the drawings and the respective embodiments, and descriptions that are the same are not repeated.

### First Embodiment

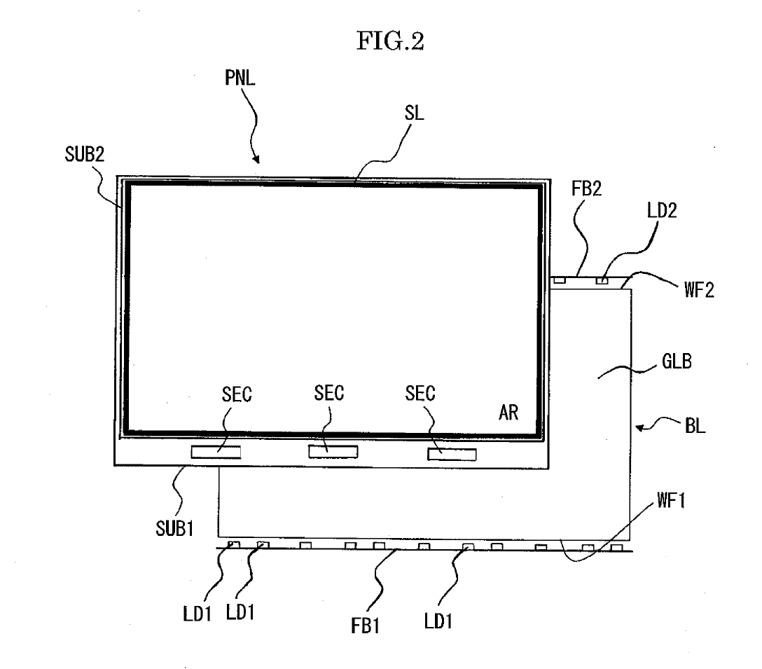

FIG. 2 is a plan diagram showing the liquid crystal display device according to the first embodiment of the present invention. The liquid crystal display device is formed of a liquid crystal display panel PNL and a backlight BL provided in the rear of the liquid crystal display panel PNL. Though in FIG. 2 the backlight BL is not aligned with the liquid crystal display panel PNL, the backlight BL is actually provided so as to perfectly overlap with the rear of the liquid crystal display panel PNL.

The liquid crystal display panel PNL is formed of a housing made of a substrate SUB1 and a substrate SUB2 which are positioned so as to face each other and sandwich liquid crystal (not shown). The substrate SUB2 is provided so as to overlap with the above described substrate SUB1 in such a manner that the lower side of the substrate SUB1 in the figure is slightly exposed, for example, and secured to the above described substrate SUB1 with an annular sealing material SL formed around the substrate SUB2, so that the above described liquid crystal is sealed in. The region surrounded by the sealing material SL forms a liquid crystal display region AR, and this liquid crystal display region AR is formed of a great number of pixels (not shown) that are aligned in a matrix with liquid crystal as one component.

These pixels are independently driven by an output signal from a semiconductor device SEC (for example a driver IC chip) mounted on the lower side of the above described substrate SUB1 in the figure. In the case of FIG. 2, there are three semiconductor devices SEC, for example, and these semiconductor devices SEC are provided at equal intervals along the lower side of the substrate SUB1 in the figure.

The above described backlight BL is of a so-called edge light type and formed of a light guiding plate GLB and light emitting diodes LD that are provided on a side wall of this light guiding plate GLB. The light guiding plate GLB is formed of a rectangular resin plate and is large enough to cover at least the liquid crystal display region AR of the liquid crystal display panel PNL. The side of the light guiding plate GLB on the side where the above described semiconductor devices SEC are aligned on the liquid crystal display panel PNL (first side) has a side wall WF1, and a number of light emitting diodes LD (LD1 in the figure) are aligned along this side wall WF1. These light emitting diodes LD1 are mounted on a wiring board FB1 that is provided so as to face the above described side wall WF1, and the surface of the light emitting diodes LD1 through which light is emitted is directed toward the above described side wall WF1. In addition, a number of light emitting diodes LD (LD2 in the figure) are aligned along a side wall WF2 that faces the above described side wall WF1 along the sides of the light guiding plate GLB. These light emitting diodes LD2 are mounted on a wiring board FB2 that is positioned so as to face the above described side wall WF2, and the surface of the light emitting diodes LD2 through which light is emitted is directed toward the above described side wall WF2.

This backlight BL functions as a surface light source where light from the light emitting diodes LD1 and LD2 passes through the side walls WF1 and WF2, respectively, and is guided into the light guiding plate GLB and repeatedly reflected within the light guiding plate GLB, and after that, light is emitted through the surface facing the liquid crystal display panel PNL. In addition, light emitting diodes LD1 and LD2 are respectively provided on a pair of side walls WF1 and WF2 which face each other through the light guiding plate GLB, and thus, a great number of light emitting diodes can be provided, so that the backlight BL is highly bright.

Here, though not shown in FIG. 2, in some cases an optical sheet, such as a prism sheet, is provided between the liquid crystal display panel PNL and the backlight BL.

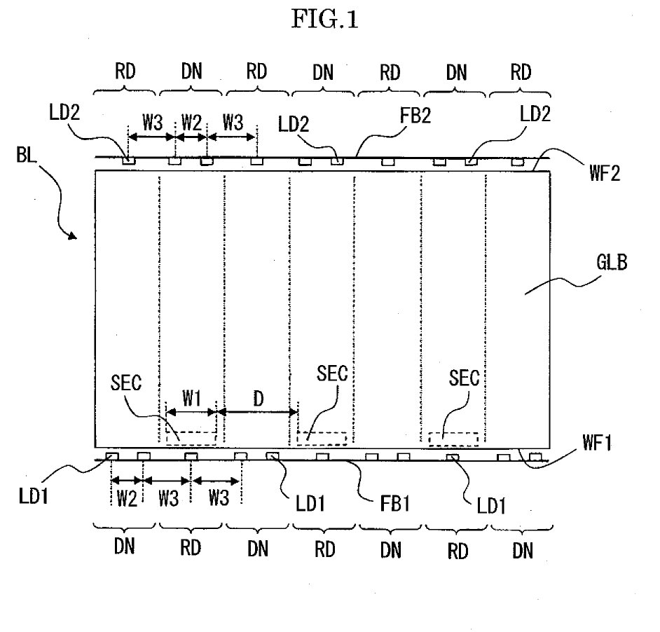

FIG. 1 is a plan diagram showing only the above described backlight BL. In addition, dotted boxes in the figure indicate places where semiconductor devices SEC are located in the case where a liquid crystal display panel PNL is provided on this backlight BL in such a manner as to overlap with it. There are three semiconductor devices SEC, for example, and the width W1 is 19.0 mm for 10.5 inch liquid crystal display panels, and the distance D between adjacent semiconductor devices SEC is 23.2 mm, for example.

Light emitting diodes DL1 are aligned along the above described side wall WF1 in the backlight BL with different distances between the light emitting diodes DL1, so that a dense region (DN), a scarce region (RD), a dense region (DN), a scarce region (RD), a dense region (DN), a scarce region (RD) and a dense region (DN) are secured starting from the left in the figure, for example. Here, as shown in FIG. 1, the distance between light emitting diodes DL1 in the dense regions (DN) is shorter than the distance between light emitting diodes BL1 in scarce regions (RD).

As a result, light emitting diodes DL1 are aligned in a scarce state in places in proximity to the above described semiconductor devices SEC and in a dense state in places which are not in proximity to the above described semiconductor devices SEC. In this case, two light emitting diodes LD1 are provided in dense regions (DN), for example, and the distance W2 between these is 10.0 mm, for example. In addition, one light emitting diode LD1 is provided in scarce regions (RD), and the distance W3 from the light emitting diodes LD1 in the dense regions (DN) on either side is 16.0 mm, for example.

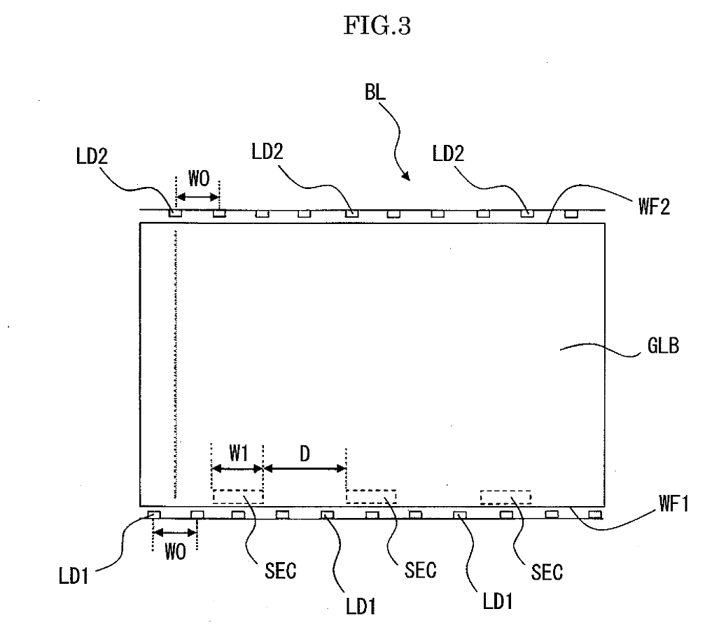

In this configuration, one light emitting diodes LD1 is provided in proximity to semiconductor devices SEC, and the light emitting diodes LD1 provided on either side of this light emitting diode are at a distance from the semiconductor devices SEC, as is clear by comparing the case in FIG. 3, for example. Therefore, the effects of heat from the light emitting diodes LD1 on the semiconductor devices SEC can be greatly reduced.

Here, the distance between light emitting diodes LD1 is not uniform, as described above, and therefore, there is a possibility that the brightness of the backlight BL may become uneven. However, the inventor of the present invention confirmed that the arrangement of the light emitting diodes LD1 under the condition: maximum distance/minimum distance ≦1.6 did not cause any practical problems in terms of the unevenness in the brightness of the backlight BL, even when the light emitting diodes LD1 are aligned with an inconsistent pitch. Therefore, light emitting diodes DL2 may be aligned with an equal pitch.

In the present embodiment, unevenness in the brightness of the backlight BL caused by the above described arrangement of the light emitting diodes LD1 can be compensated for by the arrangement of the above described light emitting diodes LD2, and is further lessened in the configuration. That is to say, light emitting diodes DL2 are aligned along the above described side wall WF2 in the backlight BL with different distances between light emitting diodes DL2, so that a scarce region (RD), a dense region (DN), a scarce region (RD), a dense region (DN), a scarce region (RD), a dense region (DN) and a scarce region (RD) are secured starting from the left in the figure, for example. In this case, the positional relationship between light emitting diodes is such that the scarce regions (RD) of light emitting diodes DL2 face dense regions (DN) of light emitting diodes DL1, while the dense regions (DN) of light emitting diodes DL2 face scarce regions (RD) of light emitting diodes DL1. Thus, two light emitting diodes LD2 are provided in dense regions (DN), for example, and the distance W2 between these is 10.0 mm, for example. In addition, one light emitting diode LD2 is provided in dense regions (RD) and the distance W3 from the light emitting diodes LD2 in the dense regions (DN) on either side is 16.0 mm, for example.

In the case of this configuration, dense regions (DN) and scarce regions (RD) of light emitting diodes LD1 can have the same number of light emitting diodes when light emitting diodes LD2 are provided in these regions, as described above. That is to say, the sum of the number of light emitting diodes LD1 formed in a certain dense region (DN) and the number of light emitting diodes LD2 formed in the scarce region (RD) that faces this dense region is equal for all facing pairs of dense regions (DN) and scarce regions (RD). Therefore, the arrangement of light emitting diodes is balanced as a whole, and thus, the brightness of the backlight BL is uniform.

Accordingly, the above described liquid crystal display device reduces the effects of heat on the semiconductor devices SEC in the liquid crystal display panel PNL, and the brightness of the backlight BL can be made uniform.

Though in the above described embodiment, two light emitting diodes LD are provided in dense regions (DN) both for light emitting diodes LD1 and LD2 while one light emitting diode LD is provided in scarce regions (RD), it is not necessary for the number of light emitting diodes LD to be limited to this. In addition, though the maximum pitch is 16.0 mm and the minimum pitch is 10.0 mm, in the alignment of the light emitting diodes LD1 and LD2, respectively, it is not necessary for the numeric value to be limited to this. However, it is desirable for the light emitting diodes LD1 and LD2 to be aligned so that maximum pitch/minimum pitch ≦1.6.

In addition, though the distance W2 in dense regions (DN) and the distance W3 in scarce regions (RD) is equal between the side along which semiconductor devices SEC are aligned (light emitting diode LD1 side) and the facing side (light emitting diode LD2 side) in FIG. 1, it is not necessary for them to be equal. That is to say, light emitting diodes LD2 may be aligned with a distance that is different than W2 in dense regions (DN), and with a distance that is different from W3 in scarce regions (RD) on the light emitting diode LD2 side.

### Second Embodiment

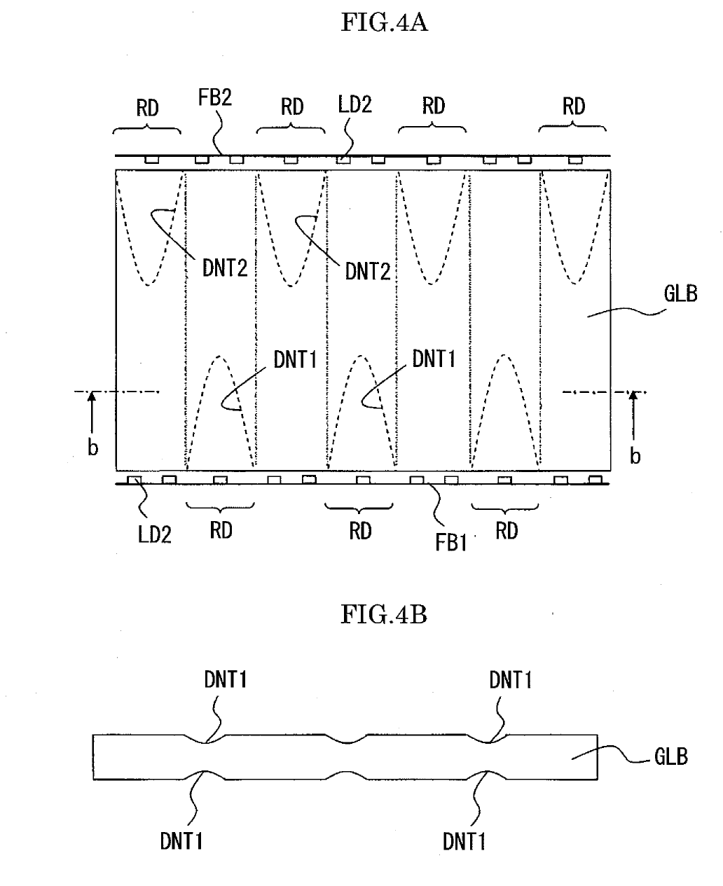

FIG. 4A is a diagram showing the liquid crystal display device according to another embodiment of the present invention, and corresponds to FIG. 1. FIG. 4B is a cross sectional diagram along line b-b in FIG. 4A.

In FIG. 4A, the state of alignment of the light emitting diodes LD1 and the state of alignment of the light emitting diodes LD2 is the same as in FIG. 1.

What is different from the case in FIG. 1 is that recesses DNT are provided (DNT1 in the figure) in portions corresponding to regions (RD) where light emitting diodes LD1 are scarce both on the front and rear surface of the light guiding plate GLD on the side wall WF1 side. These recesses DNT1 extend to the middle of the light guiding plate GLB in a direction perpendicular to the direction in which light emitting diodes LD1 are aligned, and are created so as to become shallower in the direction in which they extend, for example. Likewise, recesses DNT (DNT2 in the figure) are created in portions corresponding to the region (RD) where light emitting diodes LD2 are scarce both on the front and rear surface of the light guiding plate GLB on the side wall WF2 side. These recesses DNT2 extend to the middle of the light guiding plate GLB in a direction perpendicular to the direction in which light emitting diodes LD1 are aligned, and are created so as to become shallower in the direction in which they extend, for example.

In the case where light emitting diodes LD are scarce, the amount of light for illuminating the inside of the light guiding plate GLB is small, and therefore, the light guiding plate GLB is made thinner by creating recesses DNT, as described above, so that loss of light can be reduced within the light guiding plate GLB. As a result, the brightness of the backlight BL can be easily made uniform.

Here, though in the above described embodiment recesses DNT are created both on the front and rear surface of the light guiding plate GLB, they may be created on only one surface. This is because the recesses are provided in order to reduce the thickness of the light guiding plate GLB.

Though the present invention is described using embodiments, as described above, the structures in the embodiments are merely examples, and the present invention can be modified in various ways within such a scope as not to depart from the technological idea thereof. In addition, the structures in the respective embodiments may be combined for use insofar as they are compatible.

What is claimed is:

1. A liquid crystal display device comprising a liquid crystal display panel and a backlight provided on the rear of said liquid crystal display panel, characterized in that
said backlight comprises a light guiding plate provided so as to face at least an image display region of said liquid crystal display panel, a first light source group made up of a number of light sources that are aligned along a side wall of a first side of said light guiding plate and a second light source group made up of a number of light sources aligned along a side wall of a second side that faces said second side of said light guiding plate,
the first light source group has a first region where the distance between adjacent light sources is a first distance and a second region where the distance between adjacent light sources is a second distance that is smaller than said first distance,
said second light source group has a third region that faces said first region and a fourth region that faces said second region,
the distance between adjacent light sources in said third region is a third distance,
the distance between adjacent light sources in said fourth region is a fourth distance, and
said third distance is smaller than said fourth distance.

2. The liquid crystal display device according to claim 1, characterized in that
at least one semiconductor device is provided along the side of said liquid crystal panel on said first side, and
said semiconductor device is positioned so as to face said first region.

3. The liquid crystal display device according to claim 2, characterized in that there are a number of semiconductor devices.

4. The liquid crystal display device according to claim 1, characterized in that
the sum of the number of light sources provided in said first region and the number of light sources provided in said third region is equal to the sum of the number of light sources provided in said second region and the number of light sources provided in said fourth region.

5. The liquid crystal display device according to claim 1, characterized in that the relation between said first distance and said second distance is such that first distance/second distance ≦1.6.

6. The liquid crystal display device according to claim 5, characterized in that the relation between said third distance and said fourth distance is such that fourth distance/third distance ≦1.6.

7. The liquid crystal display device according to claim 6, characterized in that said first distance and said fourth distance are equal.

8. The liquid crystal display device according to claim 7, characterized in that said second distance and said third distance are equal.

9. The liquid crystal display device according to claim 1, characterized in that
the width of said side wall of said light guiding plate is greater at a point facing said second region than at a point facing said first region, and
the width of said side wall of said light guiding plate is greater at a point facing said third region than at a point facing said fourth region.

10. The liquid crystal display device according to claim 9, characterized in that
said light guiding plate has a first recess and a second recess on at least the front or rear surface,
said first recess is created so as to extend to said second side from the point where said side wall makes contact with said first region, and
said second recess is created so as to extend to said first side from the point where said side wall makes contact with said fourth region.

11. A liquid crystal display device comprising a liquid crystal display panel and a backlight provided on the rear of said liquid crystal display panel, characterized in that
said backlight comprises a light guiding plate provided so as to face at least an image display region of said liquid crystal display panel, a first light source group made up of a number of light sources that are aligned along a side wall of a first side of said light guiding plate and a second light source group made up of a number of light sources aligned along a side wall of a second side that faces said second side of said light guiding plate,
the first light source group has a first region where the distance between adjacent light sources is a first distance and a second region where the distance between adjacent light sources is a second distance that is smaller than said first distance,
at least one semiconductor device is provided along the side of said liquid crystal panel on the first side, and
said semiconductor device is positioned so as to face said first region.

12. The liquid crystal display device according to claim 11, characterized in that there are a number of semiconductor devices.

13. The liquid crystal display device according to claim 11, characterized in that the relation between said first distance and said second distance is such that first distance/second distance ≦1.6.

14. The liquid crystal display device according to claim 11, characterized in that
the width of said side wall of said light guiding plate is greater at a point facing said second region than at a point facing said first region.

15. The liquid crystal display device according to claim 14, characterized in that
said light guiding plate has a recess on at least the front or rear surface, and
said recess is created so as to extend to said second side from the point where said side wall makes contact with said first region.

16. The liquid crystal display device according to claim 15, characterized in that said light sources are light emitting diodes.
